(19) United States
(12) Patent Application Publication
(10) Pub. No.: US 2025/0329083 A1
(43) Pub. Date: Oct. 23, 2025

(54) VISUAL DUBBING OF AN AUDIOVISUAL SEQUENCE

(71) Applicants: DISNEY ENTERPRISES, INC., Burbank, CA (US); ETH Zürich (Eidgenössische Technische Hochschule Zürich), Zürich (CH)

(72) Inventors: Jacek Krzysztof NARUNIEC, Windlach (CH); Andrea BIONDA, Zürich (CH); Manuel Jakob KANSY, Zürich (CH); Christopher Richard SCHROERS, Uster (CH); Romann Matthew WEBER, Uster (CH)

(21) Appl. No.: 18/642,219

(22) Filed: Apr. 22, 2024

(51) Int. Cl. G06T 11/60; G06T 9/00; G06V 10/26; G06V 10/774; G06V 40/16

(52) U.S. Cl. CPC G06T 11/60; G06T 9/00; G06V 10/774; G06V 40/165; G06V 40/171; G06V 10/26

(57) ABSTRACT

The present invention sets forth a technique for performing visual dubbing on an audiovisual sequence. The technique includes identifying, based on an actor frame included in the audiovisual sequence, one or more regions of an actor's face included in the actor frame, identifying, based on a dubber frame included in a visual recording of a dubber's performance, one or more regions of a dubber's face included in the dubber frame, generating a plurality of latent vectors based on at least one identified region of the actor's face and at least one identified region of the dubber's face, and generating, via the machine learning model, an output image based on the plurality of latent vectors.

### BACKGROUND

### Field of the Various Embodiments

Embodiments of the present disclosure relate generally to machine learning and video effects processing and, more specifically, to techniques for dubbing an audiovisual sequence.

### Description of the Related Art

During the production of a live action or animated audiovisual sequence, producers, creators, dubbing directors, or distributors may wish to dub or replace one or more lines of dialogue in the audiovisual sequence with an alternate audio recording. For example, producers, creators, dubbing directors, or distributors may wish to generate a localized version of the audiovisual sequence, where dialogue included in the audiovisual sequence is replaced with a translation of the dialogue into a different language. Producers, creators, dubbing directors, or distributors may also wish to replace dialogue with an alternate version, with or without translation, to correct errors in the spoken dialogue, to achieve a different artistic goal, or to comply with ratings guidelines or societal standards.

Existing techniques for dubbing audiovisual sequences may simply replace a section of the original audio included in the audiovisual sequence with an alternate audio recording. These techniques require only that the duration of the alternate audio recording approximately matches the duration of the original audio included in the audiovisual sequence. One drawback of these techniques is that the techniques do not perform any modification of the visual portions of the audiovisual sequence. As a result, the actor's or animated character's mouth movements depicted in the dubbed audiovisual sequence may not synchronize with the alternate audio recording.

Other existing techniques may attempt to generate video based on an audio signal included in the alternate audio recording. These techniques generate facial expressions, including mouth movements, based on the audio signal and map these facial expressions as deformations onto an actor's or animated character's image included in the audiovisual sequence. One drawback to generating facial expressions from an audio signal is that the correspondence between a specific portion of the audio signal and a particular facial expression may be ambiguous. As a result, existing techniques based solely on an audio signal may not provide sufficient detail to produce a convincing, high-resolution video, for example video suitable for a live-action or animated feature film.

As the foregoing illustrates, what is needed in the art are more effective techniques for dubbing an audiovisual sequence.

### SUMMARY

One embodiment of the present invention sets forth a technique for performing visual dubbing of an audiovisual sequence. The technique comprises identifying, based on an actor frame included in the audiovisual sequence, one or more regions included in the actor frame and identifying, based on a dubber frame included in a visual recording of a dubber performance, one or more regions included in the dubber frame. The technique also comprises generating a plurality of latent vectors based on at least one identified region included in the actor frame and at least one identified region included in the dubber frame and generating an output image based on the plurality of latent vectors.

One technical advantage of the disclosed techniques relative to the prior art is that the disclosed techniques are guided by both the specific audiovisual sequence being modified and a video recording of a dubbing actor's performance. Unlike existing techniques that rely on an audio signal to generate facial expressions including mouth movements, the disclosed techniques modify mouth movements in the audiovisual sequence based on recorded mouth movements of a dubbing actor (hereinafter “dubber”), providing enhanced realism in the modified audiovisual sequence while still being computationally performant. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of training engine 122 of FIG. 1, according to some embodiments.

FIG. 3 is a flow diagram of method steps for training a machine learning model, according to some embodiments.

FIG. 4 is a more detailed illustration of inference engine 124 of FIG. 1, according to some embodiments.

FIG. 5 is a flow diagram of method steps for performing visual dubbing using a trained machine learning model, according to some embodiments.

FIG. 6 is a more detailed illustration of differential swap engine 126 of FIG. 1, according to some embodiments.

FIG. 7 is a flow diagram of method steps for performing visual dubbing using a differential swap, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

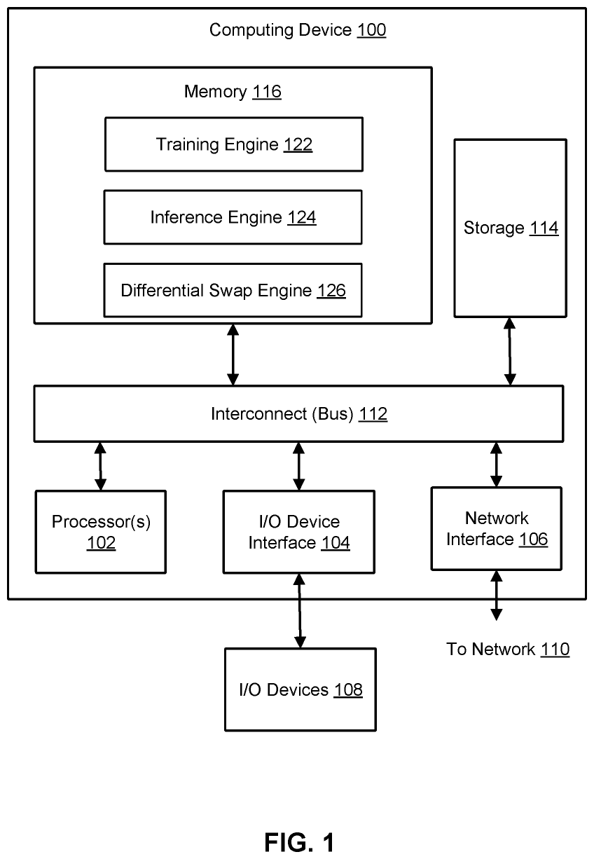

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122, an inference engine 124, and a differential swap engine 126 that reside in a memory 116.

It is noted that the computing device described herein is illustrative and that any other technically feasible configurations fall within the scope of the present disclosure. For example, multiple instances of training engine 122, inference engine 124, and differential swap engine 126 could execute on a set of nodes in a distributed and/or cloud computing system to implement the functionality of computing device 100. In another example, training engine 122, inference engine 124, and differential swap engine 126 could execute on various sets of hardware, types of devices, or environments to adapt training engine 122, inference engine 124, or differential swap engine 126 to different use cases or applications. In a third example, training engine 122, inference engine 124, and differential swap engine 126 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122, inference engine 124, and differential swap engine 126 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122, inference engine 124, and differential swap engine 126.

### Pre-Training and Fine-Tuning

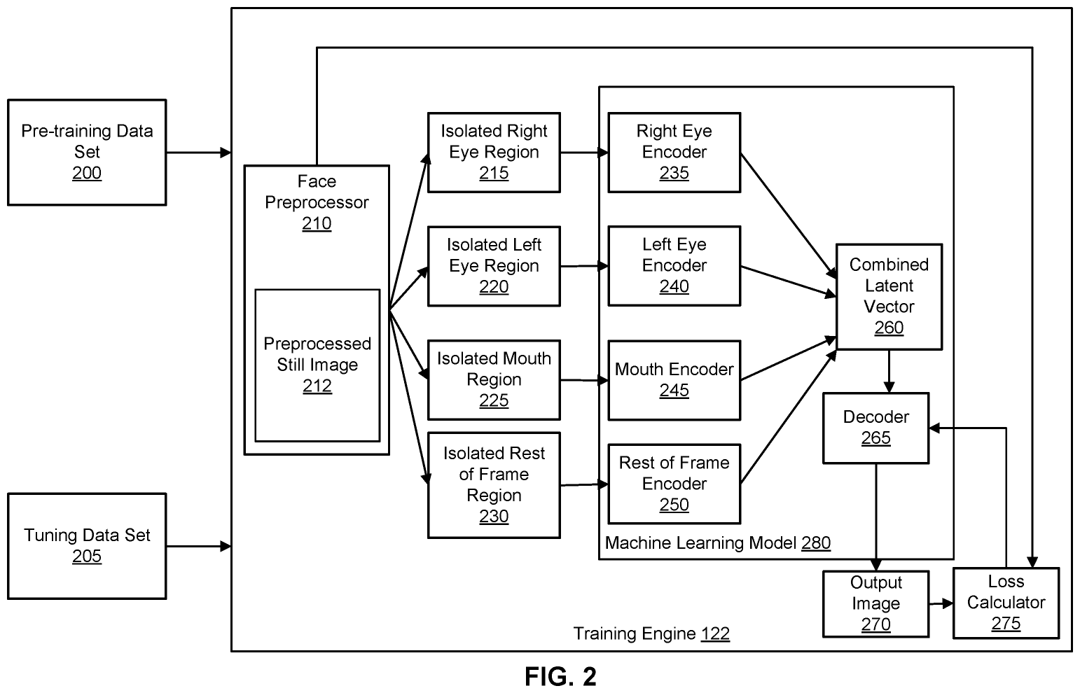

FIG. 2 is a more detailed illustration of training engine 122 of FIG. 1, according to some embodiments. Training engine 122 trains a machine learning model 280 to generate an output image representing an encoded input image. Training engine 122 further includes, without limitation, face preprocessor 210, preprocessed still image 212, isolated right eye region 215, isolated left eye region 220, isolated mouth region 225, isolated rest of frame region 230, right eye encoder 235, left eye encoder 240, mouth encoder 245, rest of frame encoder 250, combined latent vector 260, decoder 265, output image 270, and loss calculator 275.

Training engine 122 pre-trains machine learning model 280 on images included in pre-training data set 200. Pre-training data set 200 includes two-dimensional (2D) still images, with each still image depicting a face. Pre-training data set 200 may include still images representing a variety of identities, such as various different people (e.g., live actors, animated actors, or dubbers). Each still image includes an associated resolution, i.e., a height and width each expressed as a quantity of pixels. In various embodiments, training engine 122 may pre-train machine learning model 280 progressively, beginning with lower resolution still images and progressing to higher resolution still images during the pre-training.

In various embodiments, dubber faces depicted in still images included in pre-training data set 200 may be generated synthetically. For example, training engine 122 may analyze an audio-only recording of a dubber via a face synthesizer (not shown) and generate a video sequence of a synthetically generated face having mouth movements based on the audio-only recording. Training engine 122 may extract still frames from the generated video sequence for inclusion in pre-training data set 200.

Training engine 122 receives a still image from pre-training data set 200 and performs preprocessing via face preprocessor 210. Face preprocessor 210 identifies 2D coordinates within the received still image representing facial landmarks, such as the eyes, nose, mouth, eyebrows, and facial contours of a face depicted in the still image. In various embodiments, face preprocessor 210 may identify, e.g., approximately 70 facial landmarks. Face preprocessor 210 may perform face normalization on the still image, for example, via rotation and scaling. In various embodiments, face preprocessor 210 rotates the still image to place the nose and mouth along a vertical centerline and scales the still image so that the outline of the face as determined by the facial contour landmarks fills a predetermined portion of the still image. Face preprocessor 210 transmits preprocessed still image 212, including identified facial landmarks included in the still image, to loss calculator 275.

Face preprocessor 210 divides the still input into four regions-isolated right eye region 215, isolated left eye region 220, isolated mouth region 225, and isolated rest of frame region 230. Face preprocessor 210 determines the boundaries of the four regions based on the facial landmarks identified in the still image. For example, for a normalized still image having a resolution of 1024×1024 pixels, the regions representing each of isolated right eye region 215 and isolated left eye region 220 may have dimensions of 256×256 pixels and may each be centered on a location determined by an average location of the facial landmarks associated with the respective right or left eye. Face preprocessor 210 determines a boundary for isolated mouth region 225 based on the facial landmarks associated with a nose and facial contour included in the still image. In various embodiments, face preprocessor 210 determines the location of the bottom of the nose and extends straight lines from the bottom of the nose to the left and right edges of the face contour. The direction of these lines may be determined relative to the horizontal, e.g., 20 degrees above the horizontal. The boundary for isolated mouth region 225 also includes the portions of the facial contour below the intersection points of the facial contour and the straight lines. Thus, in various embodiments, the boundary for isolated mouth region 225 may begin at the bottom of the nose, extend in a straight elevated line to the right contour of the face, continue down the right facial contour to the chin, and proceed up the left contour of the face to intersect a second elevated line from the base of the nose to the left contour of the face. In various embodiments, face preprocessor may re-center the still image, such that isolated mouth region 225 appears horizontally and vertically centered within the still image.

Face preprocessor 210 determines isolated rest of frame region 230 based on the boundaries determined for isolated right eye region 215, isolated left eye region 220, and isolated mouth region 225. In particular, isolated rest of frame region 230 may include one or more portions of the still image that are not included in any of isolated right eye region 215, isolated left eye region 220, and isolated mouth region 225. Training engine 122 transmits each of isolated right eye region 215, isolated left eye region 220, isolated mouth region 225 and isolated rest of frame region 230 to machine learning model 280.

Machine learning model 280 includes machine learning encoders associated with each of the isolated regions of preprocessed still image 212, specifically right eye encoder 235, left eye encoder 240, mouth encoder 245, and rest of frame encoder 250. Each of right eye encoder 235, left eye encoder 240, mouth encoder 245, and rest of frame encoder 250 receives its associated isolated region of preprocessed still image 212 and generates a latent vector for the associated isolated region of preprocessed still image 212 that encodes latent features in the associated isolated region. In various embodiments, each of the four latent vectors are of equal length. Training engine 122 combines the generated latent vectors to form combined latent vector 260. In various embodiments, training engine 122 combines the latent vectors via concatenation. Training engine 122 transmits combined latent vector 260 to decoder 265.

Decoder 265 is a trainable machine learning decoder that generates output image 270 based on combined latent vector 260. After decoding the features included in combined latent vector 260, decoder 265 converts the decoded features into a decoded representation and transmits the decoded representation to training engine 122 as output image 270. In some implementations, the decoded representation may be an RGB (Red/Green/Blue) representation, while in other implementations, the decoded representation may be in another color space.

Training engine 122 transmits output image 270 to loss calculator 275. Loss calculator 275 generates a reconstruction loss based on the input still image from pre-training data set 200 as preprocessed by face preprocessor 210 and output image 270. In various embodiments, loss calculator 275 receives preprocessed still image 212 from face preprocessor 210 and generates a convex hull associated with preprocessed still image 212 based on the set of facial landmarks in preprocessed still image 212 identified by face preprocessor 210.

Loss calculator 275 calculates the reconstruction loss based on the face regions of preprocessed still image 212 and corresponding face regions of output image 270 as determined by the convex hull associated with preprocessed still image 212. In various embodiments, the reconstruction loss may include a mean squared error (MSE) based on differences between preprocessed still image 212 and output image 270 at corresponding 2D locations based on the convex hull associated with preprocessed still image 212. In other embodiments, the reconstruction loss may further include a structural dissimilarity index measure (DSSIM). The DSSIM represents a measure of perceived structural differences between preprocessed still image 212 and output image 270, including differences in contrast and luminance (i.e., brightness) values associated with preprocessed still image 212 and output image 270. Other embodiments of loss calculator 275 may include a generative adversarial network (GAN), where a discriminator included in the GAN attempts to differentiate between preprocessed still image 212 and an output image 270.

Based on the reconstruction loss, training engine 122 adjusts various trainable parameters included in decoder 265 and encoders 235, 240, 245, and 250. Training engine 122 may continue to iteratively train decoder 265 and encoders 235, 240, 245, and 250 on additional still images included in pre-training data set 200 until the reconstruction loss is below a predetermined threshold.

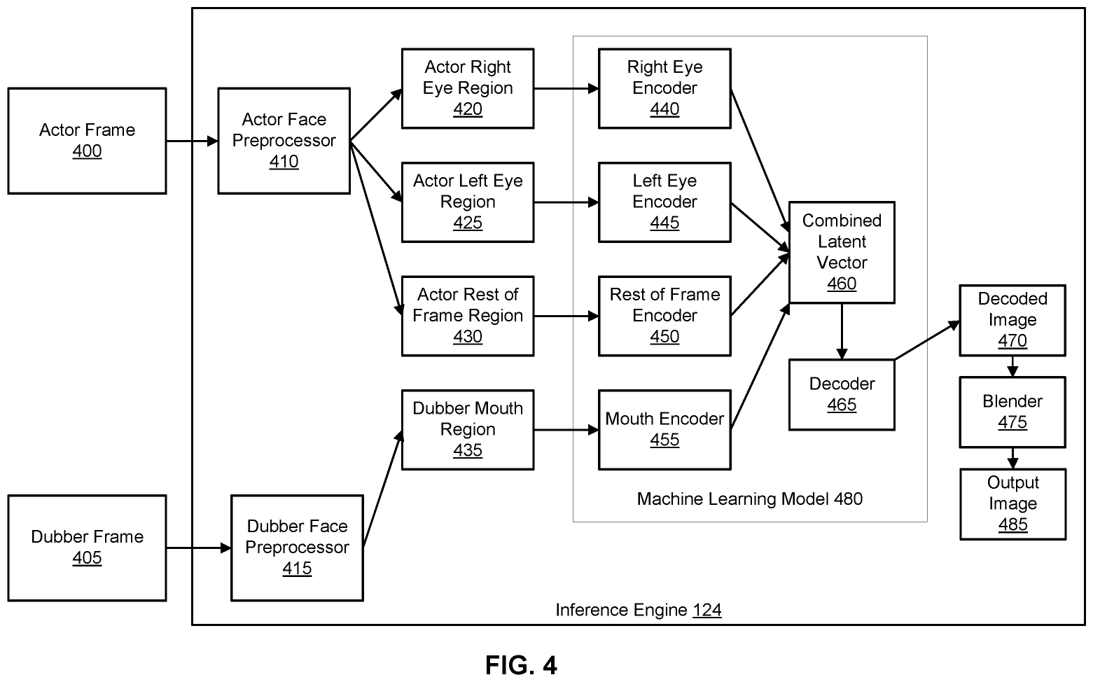

Training engine 122 may also fine-tune decoder 265 and encoders 235, 240, 245, and 250 of machine learning model 280 using still images included in tuning data set 205. The fine-tuning process is the same as the pre-training process described above, except that the still images included in tuning data set 205 only include depictions of a single actor (live or animated) and a single dubber. Specifically, the still frames depicting the single actor are taken from an audiovisual sequence to be modified at inference time, as discussed below in the detailed description of FIG. 4, and the still frames representing the single dubber are taken from the visual recording of the dubber's performance that will be used to modify the audiovisual sequence at inference time. In various embodiments, dubber faces depicted in still images included in tuning data set 205 may be generated synthetically. For example, training engine 122 may analyze an audio-only recording of a dubber via a face synthesizer (not shown) and generate a video sequence of a synthetically generated face having mouth movements based on the audio-only recording. Training engine 122 may extract still frames from the generated video sequence for inclusion in tuning data set 205. Similar to the pre-training, training engine 122 may progressively fine-tune machine learning model 280 on still images of increasing sizes included in tuning data set 205, and training engine 122 may iteratively adjust parameters of decoder 265 and encoders 235, 240, 245, and 250 based on a reconstruction loss calculated by loss calculator 275. Training engine 122 may continue to iteratively train machine learning model 280 until the reconstruction loss is below a threshold that may be different from the threshold associated with pre-training machine learning model 280.

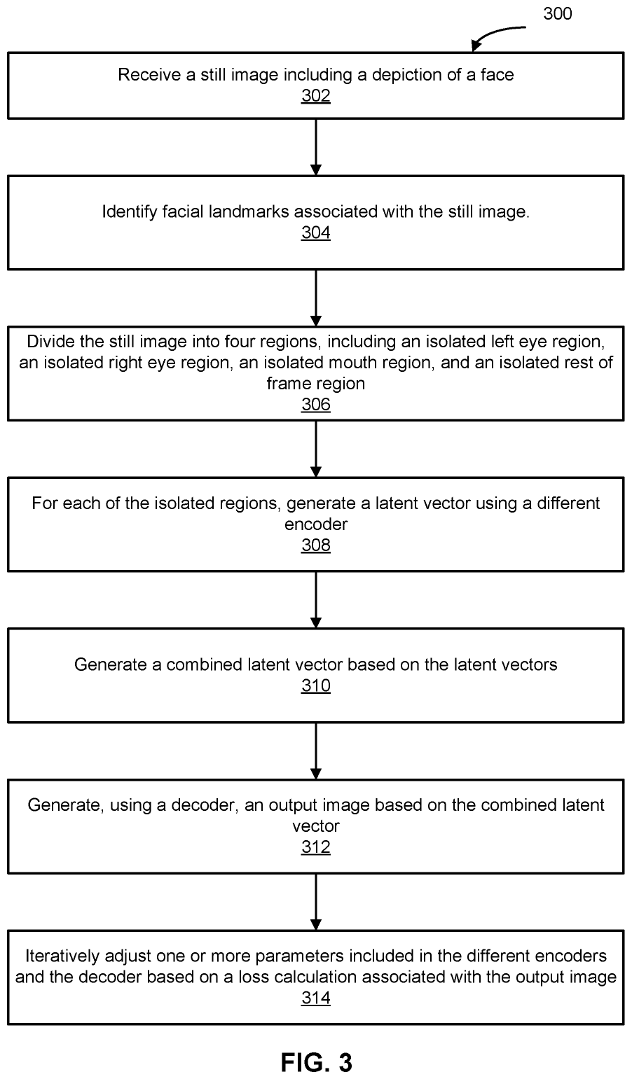

FIG. 3 is a flow diagram of method steps for training a machine learning model, according to some embodiments. Although the method steps are described in conjunction with the systems of FIGS. 1 and 2, persons skilled in the art will understand that any system configured to perform the method steps in any order falls within the scope of the present disclosure.

As shown, in operation 302 of method 300, training engine 122 receives a still image including a depiction of a face from pre-training data set 200. Still images included in pre-training data set 200 include depictions of multiple identities, such as multiple different actors and multiple different dubbers. Each still image included in pre-training data set 200 includes an associated resolution, i.e., a height and width each expressed as a quantity of pixels, and training engine 122 may progressively pre-train machine learning model 280 on increasingly higher resolution still images.

In operation 304, training engine 122 identifies, via face preprocessor 210, a set of landmarks associated with the still image, such as eyes, nose, mouth, eyebrows, and a facial contour. Face preprocessor 210 further normalizes the still image by, e.g., rotating the still image so that the nose and mouth lie on a vertical centerline and scaling the still image so that the outline of the face as determined by the facial contour landmarks fills a predetermined portion of the still image.

In operation 306, face preprocessor 210 divides preprocessed still image 212 into four regions—isolated right eye region 215, isolated left eye region 220, isolated mouth region 225, and isolated rest of frame region 230. Face preprocessor 210 determines the boundaries of isolated right eye region 215, isolated left eye region 220, and isolated mouth region 225 based on the facial landmarks identified in the still image. Isolated rest of frame region 230 includes the entirety of preprocessed still image 212 except for isolated right eye region 215, isolated left eye region 220, and isolated mouth region 225.

In operation 308, training engine 122 generates a latent vector for each of the four regions via multiple encoders included in machine learning model 280. Right eye encoder 235 generates a latent vector based on features included in isolated right eye region 215, and left eye encoder 240 generates a latent vector based on features included in isolated left eye region 220. Mouth encoder 245 generates a latent vector based on features included in isolated mouth region 225, and rest of frame encoder 250 generates a latent vector based on features included in isolated rest of frame region 230. In various embodiments, each of the four latent vectors are the same length.

In operation 310, training engine 122 combines the four latent vectors to generate combined latent vector 260. In various embodiments, training engine 122 may generate combined latent vector 260 via a concatenation of the four latent vectors. Training engine 122 transmits combined latent vector 260 to decoder 265.

In operation 312, training engine 122 generates output image 270 via decoder 265 included in machine learning model 280. After decoding the features included in combined latent vector 260, decoder 265 converts the decoded features into a decoded representation and transmits the decoded representation to training engine 122 as output image 270. In some implementations, the decoded representation may be an RGB (Red/Green/Blue) representation, while in other implementations, the decoded representation may be in another color space.

In operation 314, training engine 122 generates a reconstruction loss via loss calculator 275. The reconstruction loss is based on the input still image from pre-training data set 200 as preprocessed by face preprocessor 210 and on output image 270. Based on the reconstruction loss, training engine 122 may adjust one or more parameters included in decoder 265 and encoders 235, 240, 245, and 250.

Training engine 122 may repeat the above method steps for additional still images included in pre-training data set 200 and iteratively adjust one or more parameters included in decoder 265 and encoders 235, 240, 245, and 250 until the calculated reconstruction loss is below a predetermined threshold.

### Baseline Visual Dubbing

FIG. 4 is a more detailed illustration of inference engine 124 of FIG. 1, according to some embodiments. Via a trained machine learning model 480, inference engine 124 produces output image 485 based on an actor frame 400 included in an audiovisual sequence depicting a live or animated actor's performance and a dubber frame 405 included in a visual recording depicting a dubber's performance. Inference engine 124 modifies the appearance of the actor's mouth included in actor frame 400 based on the dubber's mouth included in dubber frame 405. Inference engine 124 includes, without limitation, actor face preprocessor 410, dubber face preprocessor 415, actor right eye region 420, actor left eye region 425, actor rest of frame region 430, and dubber mouth region 435. Machine learning model of inference engine 124 includes, without limitation, right eye encoder 440, left eye encoder 445, rest of frame encoder 450, mouth encoder 455, combined latent vector 460, and decoder 465. Inference engine 124 receives decoded image 470 from machine learning model 480 and processes decoded image 470 via blender 475 to generate output image 485.

Inference engine 124 receives actor frame 400. In various embodiments, actor frame 400 includes a still image included in an audiovisual sequence depicting an actor's performance. Inference engine 124 receives dubber frame 405 including a still image included in a visual recording of the dubber's performance.

Actor face preprocessor 410 identifies 2D coordinates within actor frame 400 representing facial landmarks, such as the eyes, nose, mouth, eyebrows, and facial contours of a face depicted in actor frame. In various embodiments, actor face preprocessor 410 may identify, e.g., approximately 70 facial landmarks. Actor face preprocessor 410 further performs face normalization on actor frame 400 via rotation and/or scaling. In various embodiments, actor face preprocessor 410 may rotate the still image to place the nose and mouth along a vertical centerline, and may scale actor frame 400 so that the outline of the face as determined by the facial contour landmarks fills a predetermined portion of actor frame 400.

Actor face preprocessor 410 divides actor frame 400 into four regions-actor right eye region 420, actor left eye region 425, actor mouth region (not shown), and actor rest of frame region 430. Actor face preprocessor 410 determines the boundaries of the four regions based on the facial landmarks identified in actor frame 400. For example, for an actor frame 400 having a resolution of 1024×1024 pixels, the regions representing each of actor right eye region 420 and actor left eye region 425 may have dimensions of 256×256 pixels and may each be centered on a location determined by an average location of the facial landmarks associated with the respective right or left eye. Actor face preprocessor 410 determines a boundary for the actor mouth based on the facial landmarks associated with a nose and a facial contour included in actor frame 400. In various embodiments, actor face preprocessor 410 determines the location of the bottom of the nose and extends straight lines from the bottom of the nose to the left and right edges of the face contour. The direction of these lines may be determined relative to the horizontal, e.g., 20 degrees above the horizontal. The boundary for the actor mouth also includes the portions of the facial contour below the intersection points of the facial contour and the straight lines. Thus, in various embodiments, the boundary for the actor mouth region may begin at the bottom of the nose, extend in a straight elevated line to the right contour of the face, continue down the right facial contour to the chin, and proceed up the left contour of the face to intersect a second elevated line from the base of the nose to the left contour of the face.

Actor face preprocessor 410 determines actor rest of frame region 430 based on the boundaries determined for actor right eye region 420, actor left eye region 425, and actor mouth. Actor rest of frame region 430 may include any portions of actor frame 400 not included in any of actor right eye region 420, actor left eye region 425, and the actor mouth region. Inference engine 124 transmits each of actor right eye region 420, actor left eye region 425, and actor rest of frame region 430 to machine learning model 480, and transmits the determined actor mouth region to blender 475.

Similarly to actor face preprocessor 410 discussed above, dubber face preprocessor 415 identifies 2D coordinates within dubber frame 405 representing facial landmarks, performs face normalization on dubber frame 405, and isolates dubber mouth region 435 based on the identified facial landmarks. Inference engine 124 transmits dubber mouth region 435 to machine learning model 480.

In various embodiments, machine learning model 480 may be the same machine leaning model as machine learning model 280 previously trained as discussed above in reference to FIG. 2. In other embodiments, machine learning model 480 may be an additional instance of machine learning model 280.

Machine learning model 480 includes machine learning encoders associated with each of the isolated image regions identified by actor face preprocessor 410 and dubber face preprocessor 415, specifically right eye encoder 440, left eye encoder 445, mouth encoder 455, and rest of frame encoder 450. Each of right eye encoder 440, left eye encoder 445, mouth encoder 455, and rest of frame encoder 450 receives its associated isolated image region and generates a latent vector for the associated isolated image region that encodes latent features in the associated isolated image region. In various embodiments, each of the four latent vectors are of equal length. Inference engine 124 combines, e.g., via concatenation, the four latent vectors to form combined latent vector 460 and transmits combined latent vector 460 to decoder 465.

Decoder 465 is a trained machine learning decoder that generates decoded image 470 based on combined latent vector 460. In some implementations, decoded image 470 may be an RGB (Red/Green/Blue) image, while in other implementations, decoded image may be represented in another color space. After decoding the features included in combined latent vector 460, decoder 465 converts the decoded features into decoded representation and transmits the decoded representation to inference engine 124 as decoded image 470. Decoded image 470 includes a depiction of the actor's face with the actor's mouth position modified based on the dubber's mouth position. Inference engine 124 transmits decoded image 470 to blender 475.

In various embodiments, blender 475 adjusts the smoothing, lighting, and contrast of a mouth region of decoded image 470 to match the surrounding regions of decoded image 470. Inference engine 124 may generate a blending mask indicating the mouth region of decoded image 470 to be blended. In some embodiments, inference engine 124 may determine the boundaries of a blending mask based on a union of the actor mouth region determined by actor face preprocessor 410 as discussed above and dubber mouth region 435. For example, if an actor mouth region determined for actor frame 400 is larger than dubber mouth region 435, inference engine 124 may generate a blending mask having the larger dimensions of the actor mouth region. Blender 475 may adjust the smoothing, lighting, and contrast of the mouth region inward from the boundaries of the blending mask to avoid adjusting regions of decoded image 470 outside of the depicted face.

In various other embodiments, blender 475 may adjust the smoothing, lighting, and contrast of a different or additional portion of decoded image 470, e.g., an entire actor face region included in decoded image 470. In these embodiments, inference engine 124 may determine the boundaries of a blending mask based on facial contours or other facial landmarks included in actor frame 400 as determined by actor face preprocessor 410 described above. Blender 475 generates output image 485 representing a single visually dubbed frame based on actor frame 400 and dubber frame 405.

Inference engine 124 may generate a visually dubbed audiovisual sequence by repeating the above process for additional instances of actor frame 400 and dubber frame 405. In some embodiments, each additional instance of actor frame 400 may be associated with a different additional instance of dubber frame 405. In other embodiments, a single additional instance of dubber frame 405 may be associated with multiple additional instances of actor frame 400. For example, a single additional instance of dubber frame 405 including a closed mouth may be associated with multiple additional instances of actor frame 400, resulting in multiple additional instances of output image 485 in which the actor's mouth remains closed.

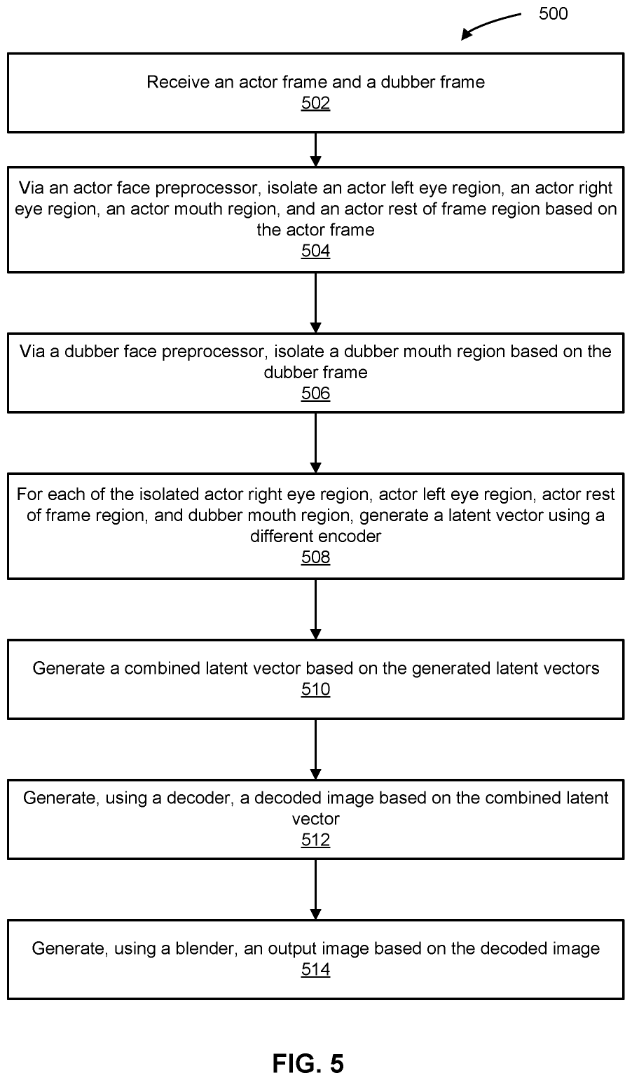

FIG. 5 is a flow diagram of method steps for performing visual dubbing using a trained machine learning model, according to some embodiments. Although the method steps are described in conjunction with the systems of FIGS. 1-2 and 4, persons skilled in the art will understand that any system configured to perform the method steps in any order falls within the scope of the present disclosure.

As shown, in operation 502 of method 500, inference engine 124 receives actor frame 400 and dubber frame 405. Actor frame 400 is a still image included in an audiovisual sequence including a depiction of an actor, and dubber frame 405 is a still image included in a visual recording of a dubber.

In operation 504, inference engine 124 isolates actor right eye region 420, actor left eye region 425, and actor rest of frame region 430 based on actor frame 400. Via actor face preprocessor 410, inference engine 124 identifies a set of facial landmarks included in actor frame 400, rotates and scales actor frame 400, and identifies regions of actor frame 400 corresponding to the actor's left eye, the actor's right eye, the actor's mouth, and the rest of actor frame 400 based on the set of facial landmarks.

In operation 506, inference engine 124 identifies a set of facial landmarks included in dubber frame 405, rotates and scales dubber frame 405, and identifies a region of dubber frame 405 corresponding to the dubber's mouth based on the set of facial landmarks. In various embodiments, inference engine 124 may perform operation 506 after operation 504, before operation 504, or in parallel with operation 504.

In operation 508, inference engine 124, via encoders included in machine learning model 480, generates latent vectors corresponding to each of actor right eye region 420, actor left eye region 425, actor rest of frame region 430, and dubber mouth region 435. In various embodiments, the four generated latent vectors have the same length. In various embodiments, inference engine 124 may perform operation 508 in parallel with operation 504, after operation 504 and before operation 506, and/or after operation 506 as inference engine 124 identifies various regions included in actor frame 400 and/or dubber frame 405.

In operation 510, inference engine 124, via machine learning model 480, combines, e.g., via concatenation, the latent vectors generated in operation 508 to generate combined latent vector 460. Combined latent vector 460 includes features from the actor's left eye, the actor's right eye, the rest of actor frame 400, and the dubber's mouth.

In operation 512, inference engine124 generates, via decoder 465 included in machine learning model 480, a decoded image 470 based on combined latent vector 460. Decoded image 470 includes a depiction of the actor, with the actor's mouth position modified based on dubber frame 405. In some implementations, decoded image 470 may be an RGB (Red/Green/Blue) image, while in other implementations, decoded image may be represented in another color space.

In operation 514, inference engine 124 processes decoded image 470 via blender 475 to generate output image 485. Blender 475 may adjust the smoothing, lighting, and contrast of a portion of decoded image 470. Output image 485 represents one frame of a visually dubbed audiovisual sequence. Inference engine 124 may repeat the above method steps on additional instances of actor frame 400 and dubber frame 405 to generate additional frames of the dubbed audiovisual sequence. The dubbed audiovisual sequence depicts the actor's performance, with the actor's mouth movements modified to match the visual recording of the dubber's mouth movements.

### Double Swapping

Various embodiments of the disclosed invention include one or more additions or modifications to the techniques discussed above in the descriptions of FIGS. 4 and 5. In one such embodiment, inference engine 124 performs a double swap technique based on actor frame 400 and dubber frame 405. In the double swap technique, inference engine 124 first performs the dubbing technique, as described above in reference to FIGS. 4 and 5, to produce output image 485 based on the isolated regions corresponding to the dubber's mouth, the actor's left eye, the actor's right eye, and the rest of actor frame 400. Inference engine 124 then repeats the dubbing technique, replacing dubber frame 405 with output image 485, such that the inputs to inference engine 124 include actor frame 400 and the output image 485 representing the previously dubbed version of actor frame 400. Inference engine 124 generates a new output image 485 based on actor frame 400 and the previous output image 485. The new output image 485 produced by the double swap technique may exhibit greater realism, more accurate facial positioning, and fewer artifacts compared to the output image 485 based on actor frame 400 and dubber frame 405. In various embodiments, inference engine 124 may repeat the double swap technique several times to produced further refined instances of output image 485. Inference engine 124 may apply the double swap technique to a single instance of actor frame 400 or to multiple instances of actor frame 400 included in an audiovisual sequence.

### Average Shift Correction

Inference engine 124 may perform an average shift correction technique to correct systemic errors in visual dubbing output, e.g., if an actor's mouth as depicted in a visually dubbed output audiovisual sequence is consistently opened wider than the dubber's mouth in the visual recording of the dubber's performance. In the average shift correction technique, inference engine 124 encodes an actor mouth latent vector associated with each actor frame 400 included in an audiovisual sequence and generates an average value of the encoded actor mouth latent vectors. Inference engine 124 further encodes a dubber mouth latent vector associated with each dubber frame 405 included in a visual recording of the dubber's performance and generates an average value of the encoded dubber mouth latent vectors.

Inference engine 124 then performs the visual dubbing technique as discussed above in reference to FIGS. 4 and 5. During the visual dubbing, inference engine 124 subtracts the average value of the encoded dubber mouth latent vectors from each latent vector generated by mouth encoder 455 and adds the average value of the encoded actor mouth latent vectors to the result. Inference engine 124 combines the modified mouth latent vector with the latent vectors generated by right eye encoder 440, left eye encoder 445, and rest of frame encoder 450 to form combined latent vector 460. Inference engine 124 decodes combined latent vector 460 via decoder 465 and generates output image 485 as discussed in the descriptions of FIGS. 4 and 5.

### Differential Swap

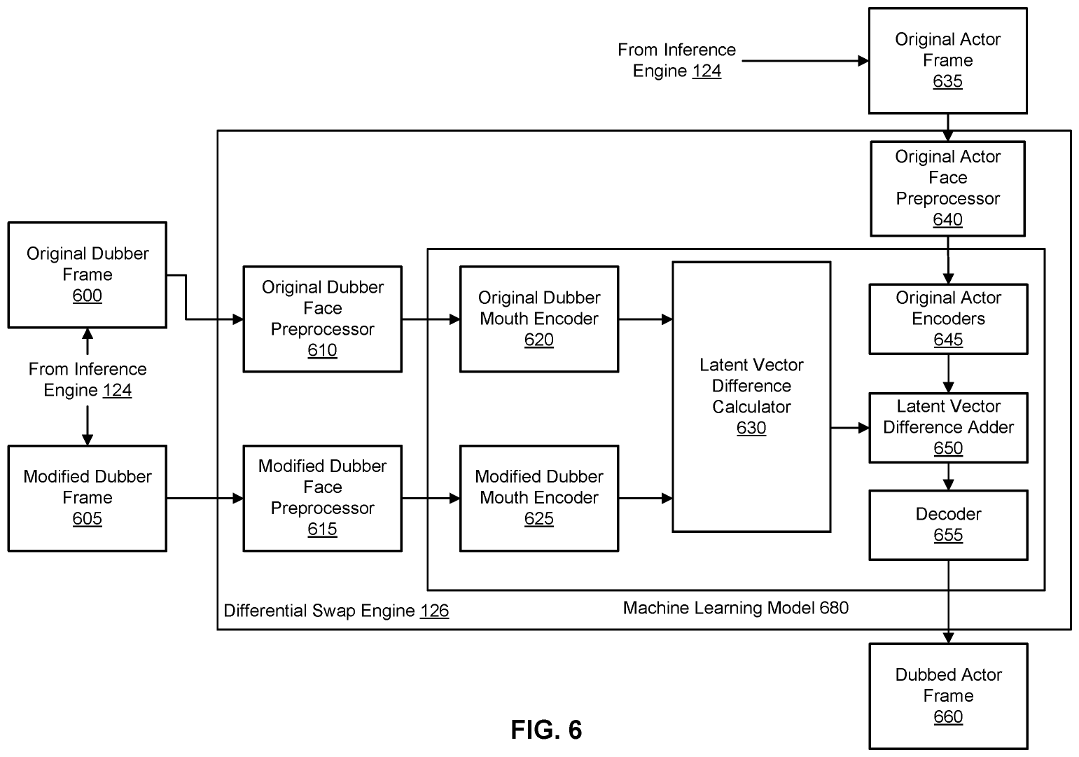

FIG. 6 is a more detailed illustration of differential swap engine 126 of FIG. 1, according to some embodiments. Differential swap engine 126 performs visual dubbing on an audiovisual sequence depicting an actor's performance based on the output of an instance of inference engine 124 in which the actor frame 400 and dubber frame 405 inputs have been reversed. Differential swap engine 126 includes, without limitation, original dubber face preprocessor 610, modified dubber face preprocessor 615, original actor face preprocessor 640, and machine learning model 680 that includes original dubber mouth encoder 620, modified dubber mouth encoder 625, latent vector difference calculator 630, original actor encoders 645, latent vector difference adder 650, and decoder 655.

In the differential swap technique, inference engine 124 first generates an output image 485 as discussed above in the descriptions of FIGS. 4 and 5, except that the actor frame 400 and dubber frame 405 inputs are reversed, such that inference engine 124 modifies the mouth position of dubber frame 405 based on an actor mouth position included in actor frame 400. In other words, the inputs into machine learning model 480 are dubber right eye region, dubber left eye region, dubber rest of frame region, and actor mouth region. Inference engine 124 transmits the generated output image 485 to differential swap engine 126 as modified dubber frame 605, and transmits dubber frame 405 to differential swap engine 126 as original dubber frame 600. Inference engine 124 further transmits actor frame 400 to differential swap engine 126 as original actor frame 635.

Original dubber face preprocessor 610 receives original dubber frame 600, identifies a set of 2D coordinates representing facial landmarks included in original dubber frame 600, and normalizes original dubber frame 600 through rotation and scaling. Based on the identified set of facial landmarks, original dubber face preprocessor 610 isolates a mouth region included in original dubber frame 600 and transmits the isolated mouth region to original dubber mouth encoder 620. Original dubber face preprocessor 610 performs identification of facial landmarks, normalization, and isolation of the mouth region in the same manner as face preprocessor 210 discussed above in reference to FIG. 2 or dubber face preprocessor 415 discussed above in reference to FIG. 4.

Modified dubber face preprocessor 615 receives modified dubber frame 605, identifies a set of 2D coordinates representing facial landmarks included in modified dubber frame 605, and normalizes modified dubber frame 605 through rotation and scaling. Based on the identified facial landmarks, modified dubber face preprocessor 615 isolates a mouth region included in modified dubber frame 605 and transmits the isolated mouth region to modified dubber mouth encoder 625. Modified dubber face preprocessor 615 performs identification of facial landmarks, normalization, and isolation of the mouth region in the same manner as face preprocessor 210 discussed above in reference to FIG. 2 or dubber face preprocessor 415 discussed above in reference to FIG. 4.

Machine learning model 680 includes original dubber mouth encoder 620, modified dubber mouth encoder 625, latent vector difference calculator 630, original actor encoders 645, latent vector difference adder 650, and decoder 655. In various embodiments, training engine 122 may pre-train or fine-tune one or more of original dubber mouth encoder 620, modified dubber mouth encoder 625, original actor encoders 645, or decoder 655 as discussed above in the detailed description of FIG. 2.

Original dubber mouth encoder 620 receives the isolated mouth region of original dubber frame 600 from original dubber face preprocessor 610. Original dubber mouth encoder 620 generates a latent vector representing features included in the isolated mouth region. Original dubber mouth encoder 620 transmits the latent vector to latent vector difference calculator 630.

Modified dubber mouth encoder 625 receives the isolated mouth region of modified dubber frame 605 from modified dubber face preprocessor 615. Modified dubber mouth encoder 625 generates a latent vector representing features included in the isolated mouth region. Modified dubber mouth encoder 625 transmits the latent vector to latent vector difference calculator 630.

Latent vector difference calculator 630 calculates a vector difference between the latent vectors received from original dubber mouth encoder 620 and modified dubber mouth encoder 625. Specifically, latent vector difference calculator 630 calculates the vector difference by subtracting the latent vector associated with the original dubber mouth from the latent vector associated with the modified dubber mouth. This vector difference represents a change in the dubber's mouth position generated by inference engine 124 based on the actor's mouth position. Latent vector difference calculator 630 transmits the vector difference to latent vector difference adder 650.

Differential swap engine 126 receives original actor frame 635 from inference engine 124. Original actor face preprocessor 640 identifies a set of 2D coordinates representing facial landmarks included in original actor frame 635, normalizes original actor frame 635 via rotation and scaling, and isolates a right eye, left eye, mouth, and rest of frame region included in actor frame 635. Original actor face preprocessor 640 performs identification of facial landmarks, normalization, and isolation of the regions in the same manner as face preprocessor 210 discussed above in reference to FIG. 2 or actor face preprocessor 410 discussed above in reference to FIG. 4. Original actor face preprocessor 640 transmits the isolated right eye region, left eye region, mouth region, and rest of frame region of original actor frame 635 to original actor encoders 645.

Original actor encoders 645 receive the isolated right eye region, left eye region, mouth region, and rest of frame region of original actor frame 635 from original actor face preprocessor 640. Each of original actor encoders 645 generates a latent vector representing features included in a different one of the isolated right eye region, left eye region, mouth region, and rest of frame region of original actor frame 635. Original actor encoders 645 transmit the generated latent vectors to latent vector difference adder 650.

Latent vector difference adder 650 generates a summation vector via vector addition on the latent mouth vector received from original actor encoders 645 and the vector difference received from latent vector difference calculator 630. Latent vector difference adder 650 transmits the summation vector to decoder 655, along with the original actor right eye, left eye, and rest of frame latent vectors received from original actor encoders 645.

Decoder 655 decodes the summation vector and the original actor right eye, left eye, and rest of frame latent vectors to generate dubbed actor frame 660. In various embodiments, differential swap engine 126 may perform blending on dubbed actor frame 660 via a blender (not shown) as discussed above in reference to blender 475 of FIG. 4.

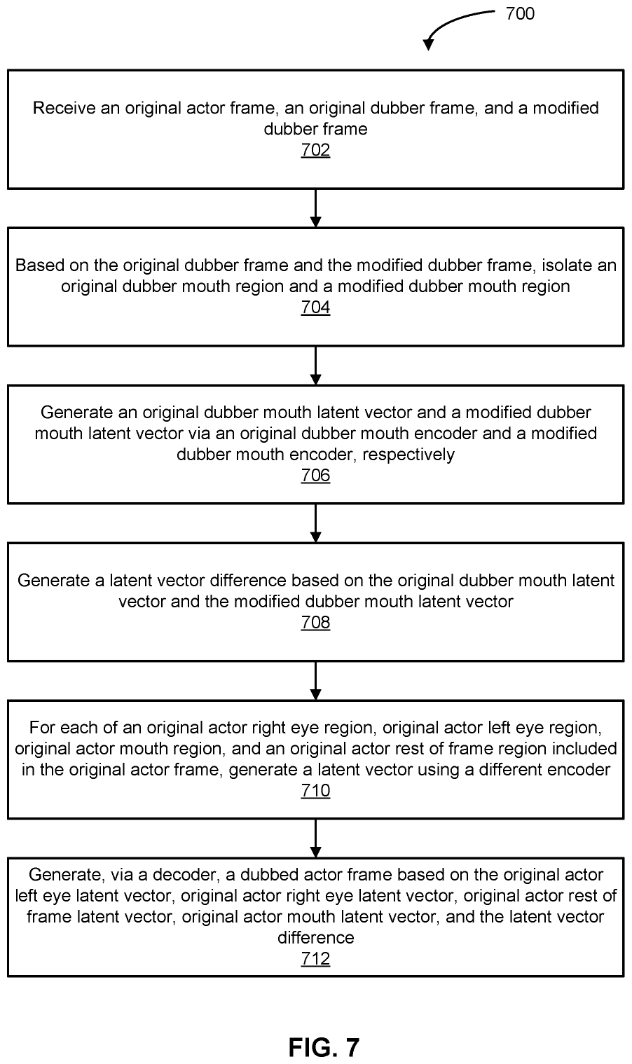

FIG. 7 is a flow diagram of method steps for performing visual dubbing using a differential swap, according to some embodiments. Although the method steps are described in conjunction with the systems of FIGS. 1-2, 4, and 6, persons skilled in the art will understand that any system configured to perform the method steps in any order falls within the scope of the present disclosure.

As shown, in operation 702 of method 700, differential swap engine 126 receives an original actor frame 635, an original dubber frame 600, and a modified dubber frame 605 from inference engine 124. Inference engine 124 generates modified dubber frame 605 based on execution of the baseline visual dubbing technique as discussed above in the descriptions of FIGS. 4 and 5, except that actor frame 400 and dubber frame 405 have been switched as inputs. By switching actor frame 400 and dubber frame 405, inference engine generates modified dubber frame 605 where the dubber's mouth position has been modified based on a mouth position included in actor frame 400.

In operation 704, differential swap engine 126 isolates an original dubber mouth region based on original dubber frame 600, and a modified dubber mouth region based on modified dubber frame 605. Differential swap engine 126 isolates the original dubber mouth region via original dubber face preprocessor 610, and isolates the modified dubber mouth region via modified dubber face preprocessor 615.

In operation 706, differential swap engine 126 generates an original dubber mouth latent vector via original dubber mouth encoder 620, and generates a modified dubber mouth latent vector via modified dubber mouth encoder 625. Each of the original dubber mouth latent vector and the modified dubber mouth latent vector includes latent features associated with the original dubber mouth region and modified dubber mouth region, respectively. In various embodiments, differential swap engine 126 may perform operation 706 in parallel with operation 704. For example, differential swap engine 126 may generate an original dubber mouth latent vector based on the original dubber mouth region prior to isolating the modified dubber mouth region in operation 704.

In operation 708, differential swap engine 126 calculates a latent vector difference based on the original dubber mouth latent vector and the modified dubber mouth latent vector. The latent vector difference represents the change in the dubber mouth position calculated by inference engine 124 based on the actor mouth position included in actor frame 400.

In operation 710, differential swap engine 126 generates original actor right eye, left eye, mouth, and rest of frame latent vectors based on original actor frame 635. Differential swap engine 126 processes original actor frame 635 via original actor face preprocessor 640 to isolate original actor right eye, left eye, mouth, and rest of frame regions. Differential swap engine 126 transmits the isolated original actor mouth region to original actor encoders 645, and original actor encoders 645 generate latent vectors that represent latent right eye, left eye, mouth, and rest of frame features included in original actor frame 635. In various embodiments, differential swap engine 126 may perform operation 710 immediately before, immediately after, or in parallel with any of operations 704, 706, or 708.

In operation 712, differential swap engine 126 performs vector addition on the mouth latent vector received from original actor encoders 645 and the vector difference received from latent vector difference calculator 630 to generate a summed mouth latent vector. Latent vector difference adder 650 transmits the summed mouth latent vector and the right eye, left eye, and rest of frame latent vectors to decoder 655. Decoder 655 decodes the summed mouth latent vector and the right eye, left eye, and rest of frame latent vectors to generate dubbed actor frame 660.

In sum, the disclosed techniques perform visual dubbing in an audiovisual sequence by replacing an original actor's mouth movements in the audiovisual sequence with mouth movements captured from one or more visual recordings of a dubbing actor, or “dubber.” For each frame of the audiovisual sequence, the disclosed technique may generate a frame of the original actor with a new mouth position matching the mouth position of the dubber in a corresponding frame of the visual recording.

The disclosed techniques include pre-training, via a training engine, a machine learning model on a pre-training data set of individual frames included in visual recordings. The individual frames include depictions of actors' and/or dubbers' faces. During pre-training, the training engine isolates regions of an individual frame, such as the left eye, the right eye, the mouth, and the entire frame excepting the isolated eyes and mouth. The machine learning model encodes each of the isolated regions of the frame into a different latent vector and combines the different latent vectors into a combined latent vector. The machine learning model then decodes the combined latent vector into a generated depiction of a face. The pre-training goal for the machine learning model is reconstruction, where the generated frame matches the corresponding frame included in the pre-training data set. The training engine iteratively adjusts one or more parameters of the machine learning model until frames generated by the machine learning model match the corresponding frames included in the pre-training data set within a predefined threshold.

After pre-training, the training engine fine-tunes the machine learning model on a tuning data set that includes individual frames from an audiovisual sequence to be dubbed and individual frames from a visual recording of a dubber performing mouth movements to be visually dubbed into the audiovisual sequence. Similar to pre-training, the fine-tuning goal is reconstruction of individual frames included in the tuning data set within a predefined threshold.

At inference time, an inference engine processes an audiovisual sequence of an original actor to be visually dubbed and a visual recording of a dubber's performance. For each frame included in the audiovisual sequence, the inference engine identifies a corresponding frame included in the visual recording of the dubber's performance.

For a frame included in the audiovisual sequence, the inference engine isolates the original actor's left eye, right eye, mouth, and the entire frame excepting the isolated eyes and mouth. For the corresponding frame included in the visual recording of the dubber's performance, the inference engine isolates the dubber's left eye, right eye, mouth, and the entire frame excepting the isolated eyes and mouth. The fine-tuned machine learning model encodes each of the actor's left eye, the actor's right eye, the dubber's mouth, and the rest of the actor's frame excepting the actor's eyes and mouth into a different latent vector. The machine learning model then combines the different latent vectors into a combined latent vector and decodes the combined latent vector into a frame that includes a generated depiction of a face. The inference engine repeats the above process for each frame in the audiovisual sequence, producing a visually dubbed audiovisual sequence where the original actor's mouth movements have been replaced with the dubber's mouth movements.

The above techniques may be augmented or replaced with additional techniques to improve the realism of the dubbed audiovisual sequence. One additional technique is a double face swap where, after generating a frame based on an original actor frame and a dubber frame, the inference engine repeats the inference process using the original actor frame and the previously generated frame. Another additional technique is a differential swap where, rather than modifying an original actor's audiovisual sequence using a dubber's mouth movements, the dubber's visual performance is instead modified using the original actor's mouth movements. For each frame in the original dubber's performance, the inference engine calculates a latent vector difference between the dubber's original mouth position and the dubber's modified mouth position. The inference engine adds the latent vector difference to the corresponding frame of the original actor's audiovisual sequence to produce a visually dubbed audiovisual sequence of the original actor. Other techniques allow a user to artistically adjust one or more portions of a dubbed audiovisual sequence, such as adjusting a degree of mouth opening using an average shift correction. These additional techniques may be used alone or in conjunction with other techniques, and may also be applied repeatedly to improve the realism of the dubbed audiovisual sequence.

One technical advantage of the disclosed techniques relative to the prior art is that the disclosed techniques are guided by both the specific audiovisual sequence being modified and a video recording of a dubbing actor's performance. Unlike existing techniques that rely on an audio signal to generate facial expressions including mouth movements, the disclosed techniques modify mouth movements in the audiovisual sequence based on recorded mouth movements of a dubbing actor, providing enhanced realism in the modified audiovisual sequence while still being computationally performant. These technical advantages provide one or more technological improvements over prior art approaches.
1. In some embodiments, a computer-implemented method for performing visual dubbing of an audiovisual sequence comprises identifying, based on an actor frame included in the audiovisual sequence, one or more regions included in the actor frame, identifying, based on a dubber frame included in a visual recording of a dubber performance, one or more regions included in the dubber frame, generating a plurality of latent vectors based on at least one identified region included in the actor frame and at least one identified region included in the dubber frame, and generating an output image based on the plurality of latent vectors.
2. The computer-implemented method of clause 1, wherein the one or more regions included in the actor frame include an actor right eye region, an actor left eye region, and an actor mouth region, and the one or more regions included in the dubber frame include a dubber mouth region.
3. The computer-implemented method of clauses 1 or 2, wherein the one or more regions included in the actor frame further include an actor rest of frame region that includes one or more portions of the actor frame that are not included in any of the actor right eye region, the actor left eye region, or the actor mouth region.
4. The computer-implemented method of any of clauses 1-3, wherein each of the plurality of latent vectors is generated based on a different one of the actor right eye region, the actor left eye region, the actor rest of frame region, and the dubber mouth region.
5. The computer-implemented method of any of clauses 1-4, wherein each latent vector included in the plurality of latent vectors has an associated length, and the lengths associated with each of the plurality of latent vectors are equal.
6. The computer-implemented method of any of clauses 1-5, further comprising concatenating the plurality of latent vectors into a combined latent vector.
7. The computer-implemented method of any of clauses 1-6, wherein generating the output image further comprises generating, via a decoder in a machine learning model and based on the combined latent vector, a decoded image including a modified actor mouth, and modifying one or more of lighting, contrast, or smoothing associated with the modified actor mouth.
8. The computer-implemented method of any of clauses 1-7, wherein identifying the one or more regions included in the actor frame further comprises identifying a set of two-dimensional (2D) coordinates within the actor frame associated with facial landmarks included in the actor frame.
9. The computer-implemented method of any of clauses 1-8, wherein the facial landmarks include one or more of an eye, a nose, a mouth, an eyebrow, or a facial contour.
10. The computer-implemented method of any of clauses 1-9, wherein the plurality of latent vectors is a first plurality of latent vectors, further comprising identifying, based on the output image, one or more regions included in the output image, generating a second plurality of latent vectors based on at least one identified region included in the actor frame and at least one of the one or more regions included in the output image, and generating a double-swapped output image based on the second plurality of latent vectors.
11. The computer-implemented method of any of clauses 1-10, wherein generating the plurality of latent vectors is performed by a plurality of encoders included in a machine learning model.
12. The computer-implemented method of any of clauses 1-11, wherein generating the plurality of latent vectors further comprises generating an original dubber mouth latent vector based on an identified original dubber mouth region associated with the dubber frame included in the visual recording of the dubber performance, generating a modified dubber frame based on the identified original dubber mouth region and an identified original actor mouth region associated with the actor frame included in the audiovisual sequence, generating a modified dubber mouth latent vector based on the modified dubber frame, and calculating a latent vector difference based on the original dubber mouth latent vector and the modified dubber mouth latent vector.
13. The computer-implemented method of any of clauses 1-12, wherein generating the plurality of latent vectors further comprises generating an original actor mouth latent vector based on the identified original actor mouth region, and wherein generating the output image further comprises generating a summation vector based on a vector addition of the latent vector difference and the original actor mouth latent vector, decoding the summation vector via a decoder, and generating the output image based on at least the decoded summation vector.
14. The computer-implemented method of any of clauses 1-13, wherein generating the plurality of latent vectors further comprises generating an original actor mouth latent vector based on the identified original actor mouth region, and wherein the computer-implemented method further comprises generating each of the original dubber mouth latent vector, the modified dubber mouth latent vector, and the original actor mouth latent vector via a different encoder.
15. In some embodiments, one or more non-transitory computer-readable media store instructions that, when executed by one or more processors, cause the one or more processors to perform the steps of identifying, based on an actor frame included in an audiovisual sequence, one or more regions included in the actor frame, identifying, based on a dubber frame included in a visual recording of a dubber performance, one or more regions included in the dubber frame, generating a plurality of latent vectors based on at least one identified region included in the actor frame and at least one identified region included in the dubber frame, and generating an output image based on the plurality of latent vectors.
16. The one or more non-transitory computer-readable media of clause 15, wherein the one or more regions included in the actor frame include an actor right eye region, an actor left eye region, and an actor mouth region, and the one or more regions included in the dubber frame include a dubber mouth region.
17. The one or more non-transitory computer-readable media of clauses 15 or 16, wherein the instructions further cause the one or more processors to perform the step of identifying an actor rest of frame region that includes one or more portions of the actor frame that are not included in any of the actor right eye region, the actor left eye region, or the actor mouth region.
18. The one or more non-transitory computer-readable media of any of clauses 15-17, wherein the plurality of latent vectors are based on the actor right eye region, the actor left eye region, the actor rest of frame region, and the dubber mouth region.
19. The one or more non-transitory computer-readable media of any of clauses 15-18, wherein the step of identifying the one or more regions included in the actor frame further comprises identifying a set of two-dimensional (2D) coordinates within the actor frame representing facial landmarks included in the actor frame.
20. The one or more non-transitory computer-readable media of any of clauses 15-19, wherein the facial landmarks include one or more of an eye, a nose, a mouth, an eyebrow, and a facial contour.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing visual dubbing of an audiovisual sequence, the computer-implemented method comprising:
identifying, based on an actor frame included in the audiovisual sequence, one or more regions included in the actor frame;
identifying, based on a dubber frame included in a visual recording of a dubber performance, one or more regions included in the dubber frame;
generating a plurality of latent vectors based on at least one identified region included in the actor frame and at least one identified region included in the dubber frame; and
generating an output image based on the plurality of latent vectors.

2. The computer-implemented method of claim 1, wherein the one or more regions included in the actor frame include an actor right eye region, an actor left eye region, and an actor mouth region, and the one or more regions included in the dubber frame include a dubber mouth region.

3. The computer-implemented method of claim 2, wherein the one or more regions included in the actor frame further include an actor rest of frame region that includes one or more portions of the actor frame that are not included in any of the actor right eye region, the actor left eye region, or the actor mouth region.

4. The computer-implemented method of claim 3, wherein each of the plurality of latent vectors is generated based on a different one of the actor right eye region, the actor left eye region, the actor rest of frame region, and the dubber mouth region.

5. The computer-implemented method of claim 1, wherein each latent vector included in the plurality of latent vectors has an associated length, and the lengths associated with each of the plurality of latent vectors are equal.

6. The computer-implemented method of claim 1, further comprising concatenating the plurality of latent vectors into a combined latent vector.

7. The computer-implemented method of claim 6, wherein generating the output image further comprises:
generating, via a decoder in a machine learning model and based on the combined latent vector, a decoded image including a modified actor mouth; and
modifying one or more of lighting, contrast, or smoothing associated with the modified actor mouth.

8. The computer-implemented method of claim 1, wherein identifying the one or more regions included in the actor frame further comprises identifying a set of two-dimensional (2D) coordinates within the actor frame associated with facial landmarks included in the actor frame.

9. The computer-implemented method of claim 8, wherein the facial landmarks include one or more of an eye, a nose, a mouth, an eyebrow, or a facial contour.

10. The computer-implemented method of claim 1, wherein the plurality of latent vectors is a first plurality of latent vectors, further comprising:
identifying, based on the output image, one or more regions included in the output image;
generating a second plurality of latent vectors based on at least one identified region included in the actor frame and at least one of the one or more regions included in the output image; and
generating a double-swapped output image based on the second plurality of latent vectors.

11. The computer-implemented method of claim 1, wherein generating the plurality of latent vectors is performed by a plurality of encoders included in a machine learning model.

12. The computer-implemented method of claim 1, wherein generating the plurality of latent vectors further comprises:
generating an original dubber mouth latent vector based on an identified original dubber mouth region associated with the dubber frame included in the visual recording of the dubber performance;
generating a modified dubber frame based on the identified original dubber mouth region and an identified original actor mouth region associated with the actor frame included in the audiovisual sequence;
generating a modified dubber mouth latent vector based on the modified dubber frame; and
calculating a latent vector difference based on the original dubber mouth latent vector and the modified dubber mouth latent vector.

13. The computer-implemented method of claim 12,
wherein generating the plurality of latent vectors further comprises generating an original actor mouth latent vector based on the identified original actor mouth region; and
wherein generating the output image further comprises:
generating a summation vector based on a vector addition of the latent vector difference and the original actor mouth latent vector;
decoding the summation vector via a decoder; and
generating the output image based on at least the decoded summation vector.

14. The computer-implemented method of claim 12,
wherein generating the plurality of latent vectors further comprises generating an original actor mouth latent vector based on the identified original actor mouth region; and
wherein the computer-implemented method further comprises generating each of the original dubber mouth latent vector, the modified dubber mouth latent vector, and the original actor mouth latent vector via a different encoder.

15. One or more non-transitory computer-readable media storing instructions that, when executed by one or more processors, cause the one or more processors to perform the steps of:
identifying, based on an actor frame included in an audiovisual sequence, one or more regions included in the actor frame;
identifying, based on a dubber frame included in a visual recording of a dubber performance, one or more regions included in the dubber frame;
generating a plurality of latent vectors based on at least one identified region included in the actor frame and at least one identified region included in the dubber frame; and
generating an output image based on the plurality of latent vectors.

16. The one or more non-transitory computer-readable media of claim 15, wherein the one or more regions included in the actor frame include an actor right eye region, an actor left eye region, and an actor mouth region, and the one or more regions included in the dubber frame include a dubber mouth region.

17. The one or more non-transitory computer-readable media of claim 16, wherein the instructions further cause the one or more processors to perform the step of identifying an actor rest of frame region that includes one or more portions of the actor frame that are not included in any of the actor right eye region, the actor left eye region, or the actor mouth region.

18. The one or more non-transitory computer-readable media of claim 17, wherein the plurality of latent vectors are based on the actor right eye region, the actor left eye region, the actor rest of frame region, and the dubber mouth region.

19. The one or more non-transitory computer-readable media of claim 15, wherein the step of identifying the one or more regions included in the actor frame further comprises identifying a set of two-dimensional (2D) coordinates within the actor frame representing facial landmarks included in the actor frame.

20. The one or more non-transitory computer-readable media of claim 19, wherein the facial landmarks include one or more of an eye, a nose, a mouth, an eyebrow, and a facial contour.
